(19) United States
(12) Patent Application Publication
(10) Pub. No.: US 2013/0144652 A1
(43) Pub. Date: Jun. 6, 2013

(54) SYSTEMS AND METHODS FOR ASSESSING MEDICAL RECORD COMPLEXITY AND RISK OF ADVERSE EVENTS

(71) Applicant: Children's Medical Center Corporation, Boston, MA (US)

(72) Inventor: David Wintner Roberson, West Roxbury, MA (US)

(21) Appl. No.: 13/690,918

(22) Filed: Nov. 30, 2012

Related U.S. Application Data
(60) Provisional application No. 61/566,309, filed on Dec. 2, 2011.

(51) Int. Cl. G06F 19/00

(52) U.S. Cl. CPC G06F 19/3431
USPC 705/3

(57) ABSTRACT

Methods and apparatus for analyzing an electronic medical record (EMR) are provided. The method includes assigning to at least one document in the EMR, a first value, wherein the assigning is based, at least in part, on a number of characters and/or a number of digits included in each document of the at least one document, determining a second value, wherein the second value is determined based, at least in part, on the first values, determining whether the second value is above a threshold value, and outputting an indication that the second value is above the threshold value. The second value may be used for applications including, but not limited to, determining a risk of a patient associated with the EMR having an adverse event, being readmitted to a hospital, or being transferred to an intensive care unit, facilitating workload balancing, and providing documentation to a payer of healthcare services.

### BACKGROUND

Medical records for patients in hospitals are becoming increasingly complex. A medical record of a patient may comprise multiple different documents related to the patient's current condition, medical history, treatments, medications, patient's response to the treatments and medications, and other information about the patient. The medical record may include documents completed by different health care professionals who may be operating at different medical facilities. Furthermore, the medical record may comprise information of different types, such as textual data (e.g., physician's notes), images, flow sheets (i.e., a graphical representation of a changing factor, such as patient's vital signs, weight, treatments, etc.) and other types of information.

Information in a medical record may change over time. Thus, when a patient is admitted to a hospital, new information for the patient may be added to the medical record by hospital personnel. Furthermore, as the patient undergoes a medical exam or treatment, information on the patient's condition and/or a response to the treatment may be added to the medical record. A frequency with which the information in the medical record of a patient changes may depend on a frequency of medical observation of the patient.

With the adoption of computer-based technologies in healthcare systems, many medical records previously stored as a collection of paper-based documents are maintained as electronic medical records (EMRs) stored in digital form by computers. There are many examples of commercially-available EMR systems including systems provided by EMR vendors Cerner Corporation, Epic Systems, and Meditech. The EMR systems provide a user interface that enables healthcare professionals to enter medical information into the documents in the EMR using one or more input interfaces.

### SUMMARY

Medical records are often a complex aggregation of different types of information. When a patient is admitted to a hospital, medical practitioners evaluate the patient's symptoms in view of the patient's information in their medical record to determine an appropriate way to address the patient's condition. However, when the information in the patient's medical record is complex and varied, it may be difficult to process such information to identify an effective approach to address the patient's condition, reduce a likelihood of medical errors, and prevent a risk of adverse events. Currently there is no known objective measure for improving healthcare efficiency based on the information in patients' medical records. To this end, the techniques described herein relate to methods and apparatus for providing a quantitative measure of a patient's complexity based, at least in part, on an analysis of documents in the patient's medical record. The complexity measure may be used for a variety of processes to improve healthcare efficiency including, but not limited to, providing an early warning of patients at risk for adverse events, facilitating workload balancing at a medical practice, and providing documentation for healthcare payers about costs associated with patients at the medical practice.

Some embodiments relate to a computer-implemented technique for analyzing an electronic medical record (EMR). The terms “medical record,” “electronic medical record,” and “EMR” are used interchangeably in the disclosure herein. Each of these terms refers to documents stored by a medical record system that is implemented using one or more computers. It should be appreciated that a document may include any suitable amount of information in a medical record and the techniques described herein are not limited by the type or amount of information in a document. Techniques for analyzing an EMR may be embodied as a computer-implemented tool, referred to herein as a Complexity Ruler (“CR”). The CR may be configured to interact with components of a computer system that store EMRs for patients at a medical practice. The CR provides a quantitative way to evaluate a complexity of a patient. The complexity of a patient may be used, among other things, to assess risk of an adverse event to the patient that may otherwise be overlooked. The determined risk of the adverse event may be used to identify one or more actions to prevent the adverse event or mitigate the risk of the adverse event from occurring. Exemplary actions may include, but are not limited to, ensuring that adequate attention is provided to the patient in a hospital or after discharge and ensuring that the patient is examined and treated by one or more medical professionals with skills and experience adequate to address the patient's condition. The complexity of a patient may be indicative of a potential risk of an adverse event that may occur to the patient, even if the patient is determined to be not acute (e.g., patient's vital signs are normal). That is, a patient who is determined to be not acute but who is determined to be complex may have a high risk of an adverse event if the patient's condition is not addressed properly.

In some embodiments, the entire EMR, or any suitable portion thereof, acquired during any suitable time period, may be analyzed to determine the patient's complexity. The amount of information in one or more documents in a medical record may be represented using any suitable quantitative measure and documents of different types may have different quantitative measures.

Accordingly, different types of information in a medical record of the patient may be used to generate a numeric value indicating a complexity of the patient. The numeric value may be used to determine a risk of an adverse event to the patient regardless of whether the patient is acute. For example, a higher value of the complexity may indicate a higher risk of an adverse event or a major adverse event (MAE) even if the patient is determined not to be acute. One or more actions, based on the patient's complexity rather than based only on the patient's acuity, may then be determined by a healthcare provider to ensure that the patient is adequately cared for in an effort to reduce the risk of the adverse event from occurring.

Some embodiments are directed to a method of analyzing an electronic medical record (EMR), wherein the EMR includes at least one document, the method comprising: assigning to each document of the at least one document, a first value, wherein the assigning is based, at least in part, on a number of characters and/or a number of digits included in each document of the at least one document; determining, with at least one processor, a second value, wherein the second value is determined based, at least in part, on the first values assigned to each document of the at least one document; determining whether the second value is above a threshold value; and outputting an indication that the second value is above the threshold value in response to determining that the second value is above the threshold value.

Some embodiments are directed to computer-readable storage medium for use with a computer configured to store an electronic medical record (EMR), wherein the EMR includes at least one document, wherein the computer-readable storage medium is encoded with a plurality of instructions that, when executed by the computer, performs a method, comprising: assigning to each document of the at least one document, a first value, wherein the assigning is based, at least in part, on a number of characters and/or a number of digits included in each document of the at least one document; determining a second value, wherein the second value is determined based, at least in part, on the first values assigned to each document of the at least one document; determining whether the second value is above a threshold value; and outputting an indication that the second value is above the threshold value in response to determining that the second value is above the threshold value.

Some embodiments are directed to a computer system, comprising: at least one storage device configured to store an electronic medical record (EMR), wherein the EMR includes at least one document; a user interface configured to display information to a user; and at least one processor programmed to: assign to each document of the at least one document, a first value, wherein the assigning is based, at least in part, on a number of characters and/or a number of digits included in each document of the at least one document; determine a second value, wherein the second value is determined based, at least in part, on the first values assigned to each document of the at least one document; determine whether the second value is above a threshold value; and output via the user interface, an indication that the second value is above the threshold value in response to determining that the second value is above the threshold value.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart illustrating a process of determining a complexity of a medical record of a patient, in accordance with some embodiments;

FIG. 2 is a functional block diagram of an illustrative computing device in which embodiments may be implemented;

FIGS. 3A and 3B illustrate portions of an exemplary user interface that may be used with some embodiments;

FIGS. 4A and 4B are illustrations of a correlation between complexity values determined in accordance with some embodiments and healthcare providers' ratings of patient complexity;

FIGS. 5A and 5B are illustrations of a comparison between complexity values determined in accordance with some embodiments and a risk of a major adverse event;

FIGS. 6A and 6B are illustrations of a comparison between complexity values determined in accordance with some embodiments and a risk of an unplanned readmission to a hospital; and

FIGS. 7A, 7B, and 7C are illustrations of a comparison between complexity values determined in accordance with some embodiments and a risk of an unplanned transfer to an ICU/ICP at a hospital.

### DETAILED DESCRIPTION

The inventor has recognized and appreciated that conventional techniques for assessing whether a patient is at risk of having an adverse event often rely on a qualitative evaluation of a patient and the experience of the healthcare provider providing the evaluation. In scenarios where the information in a patient's medical record is complex and varied and/or for less-experienced healthcare providers, the evaluation of patients at risk for adverse events is often more difficult. Some embodiments are directed to a tool for facilitating the identification of at risk patients by analyzing information in a patient's EMR. Initial studies, discussed in more detail below, have demonstrated the predictive proficiency of the tool in identifying patients at risk for having an adverse event, patients likely to be transferred to an intensive care unit (ICU), and patients at risk of having an unplanned hospital readmission following hospital discharge. Evaluating these risks using quantitative techniques described herein may facilitate determining proper treatment plans for high-risk patients. For example, patients characterized as higher risk may be given more attention than lower risk patients in an effort to prevent an occurrence of an adverse event to the high-risk patients.

EMRs include a plurality of different types of documents describing various aspects of a patient's care at a medical practice including admission information, provider notes, flowsheets (e.g., detailing vital signs), physician orders, and discharge notes. While some patients may have an EMR with few documents that are easy to understand, other patients may have EMRs that include thousands of documents describing information related to several different conditions, diseases, and treatments. When a patient is admitted to a hospital and throughout the course of the patient's hospitalization, medical practitioners need to evaluate a considerable amount of information to determine an appropriate way to address the patient's condition. For example, healthcare providers may be required to make decisions related to patient care including, but not limited to, proper medication(s), treatment(s), amount of attention that a patient requires, and types and qualifications of a medical practitioner to treat a patient. However, if the patient's information in their EMR is complex and varied, making decisions about their care may not be straightforward. As a result, some patients who present with symptoms within normal ranges, but who have a complex EMR are sometimes overlooked as patients at high risk for having an adverse event. Moreover, as the complexity of the information in the patient's EMR increases, a risk of error in analyzing the information by healthcare providers may increase.

In some embodiments, the risk of a patient having an adverse event may be categorized using different risk levels based on the complexity of the patient's EMR. For example, some adverse events may be characterized as major adverse events (“MAEs”). Examples of an MAE include, but are not limited to, cancer, myocardial infarction, stroke, and death. Although an MAE is one categorization of an adverse event, the techniques described herein for analyzing patient complexity to predict patient risk of adverse events is not limited to detecting risk associated with an MAE and risk associated with any other type of an adverse event that has a negative impact on patient's health and life may alternatively be used.

The inventor has recognized and appreciated that evaluating a complexity of a patient may be determined based, at least in part, on evaluating information in an EMR for the patient. For the sake of simplicity, a complexity of an EMR of a patient and a complexity of the patient are used interchangeably throughout this description. Though, it should be appreciated that in some instances, such as when a medical record is not current regarding a particular condition of the patient, a complexity of the patient may be different from a complexity of the patient's EMR.

In some embodiments, an EMR includes a plurality of documents and information in one or more of the documents in the EMR may be analyzed to evaluate the complexity of the patient. Accordingly, some embodiments provide a tool for determining a complexity of a patient. The tool, which may be referred to by way of example as a Complexity Ruler (“CR”), may implement techniques for a quantitative analysis of at least some information in an EMR to determine a numerical value for individual documents in the EMR and for the EMR as a whole. The determined value may be used to determine, among other things, a risk that the patient may have an adverse event. Adverse events may result from a number of factors including, but not limited to, a lack of adequate attention to the patient and absence of timely examination of the patient by a medical professional with experience and skills required to adequately address the patient's condition.

In some embodiments, the CR may analyze information in a patient's EMR to determine a complexity of a patient and, based on the determined complexity, a risk of an adverse event to the patient may be determined in real time. The techniques described herein for assessing a risk of an adverse event to a patient may be determined at any suitable time including, but not limited to, when the patient is admitted to a hospital, when information is added to the medical record, and periodically throughout an inpatient stay at a hospital. In this way, medical personnel may become aware of the risk of an adverse event to the patient with no or a small delay, so that a suitable risk-reduction strategy may be implemented in a timely and effective manner. Accordingly, the CR alleviates the cognitive burden on medical practitioners to manually process the information in the EMR of a patient. Moreover, the CR determines a complexity of a patient using a quantitative approach, which may be an easier and more straightforward approach than approaches that employ multiple clinical variables.

A conventional technique for prioritizing patient care is based on an evaluation of the acuity of a patient's presenting symptoms or conditions. For example, patients who are hospitalized, but present with normal vital signs may be determined to be not acute. The inventor has recognized, however, that the complexity of a patient may be different than the patient's acuity. For example, a patient determined to be not acute may nevertheless be determined to be complex and thereby may have an increased risk of having an adverse event as a result of this complexity. Thus, when the patient is determined to be not acute (e.g., patient's vital signs are normal and the patient's condition is not life-threatening), if the information in the patient's EMR is determined to be complex (e.g., as determined by being above a particular threshold, as discussed in more detail below), certain risk factors pertaining to the patient may be neglected because the patient may be treated based on the determination that the patient is not acute without regard to the patient's complexity. Although patients determined to be acute, regardless of their complexity, are easier to identify, patients that are not acute but complex may often be overlooked. In some embodiments, the techniques described herein facilitate identification of patients determined to be not acute but complex. Identification of such patients enables medical personnel to take appropriate actions to reduce a risk of a medical error and other adverse consequences that may result from failing to identify that a patient needs particular attention.

Different medical conditions that are not considered acute, if not addressed properly, may lead to an adverse event for certain patients. For example, a patient with a broken foot may be not be considered acute if the patient's vital signs are normal and the injury is not life-threatening. However, a complexity of a medical record of the patient (e.g., a complexity determined over the last 24 hours or within other recent period of time) may indicate that the patient is complex and may therefore need to be examined and treated by an experienced foot surgeon, rather than by a less experienced medical practitioner. For example, if this patient's condition is addressed without taking into consideration the patient's complexity, one or more complications may arise from an improperly treated broken foot, which may ultimately affect the patient's ability to walk and severely decrease the quality of the patient's life. As another example, a complex patient may be a child having normal vital signs but also having different unclear symptoms. If the child is addressed as a non-acute patient, a potential MAE, such as a cardiac arrest, may result due to the lack of proper attention to this patient. Use of the CR in accordance with the techniques described herein may facilitate identification of such complex patients that may be determined to be not acute. A proper measure to address the patient's condition may then be determined in an effort to decrease a risk of an adverse event occurring to the patient.

In some embodiments, the CR may be used to determine a complexity of a patient based on information in one or more documents included in an EMR. The information in the medical record may be processed to generate a numeric value indicating a complexity of the information. The numeric value may be generated in any suitable manner. For example, in some embodiments, prior to determining the numeric value, the information in the medical record may be processed to remove information referred to herein as metadata. In some embodiments, metadata may include information that is not descriptive of a condition of the patient and may thus not be medically relevant information. For example, the metadata may comprise one or more identifiers of the patient, one or more identifiers of a person that entered information into the medical record, any other types of identifiers, comments, bar codes, headers and/or footer information, and any other suitable information that may not be useful in determining a complexity of the patient. In some embodiments, metadata such as header and/or footer information may be removed for some documents and not others. Information may be determined to be metadata based on the complexity of a language (e.g., English) and numerical data. The metadata may be removed from information in the medical record in any suitable manner, including not being physically removed from the medical record, but merely being ignored during the calculation of a complexity value in accordance with the techniques described herein.

Regardless of whether and how metadata is removed from information in a medical record, resulting medically-relevant information may be used to determine a complexity of the patient. It should be appreciated that, throughout this description, information used to determine a complexity of the patient may be taken as information from which metadata was removed in accordance with some embodiments. Though, it should be appreciated that removal of the metadata, as well as a type and amount of metadata may be optional and that embodiments are not limited to a particular technique of processing information in a medical record prior to generating a numeric value indicating a complexity of the information.

In some embodiments, the CR may be used to represent an amount of information in an EMR as a number of bits. Each EMR may include one or more documents that may be analyzed to determine a number of bits for each of the documents. The analyzed documents may include textual information (e.g., notes) and/or non-textual information (e.g., images). Textual information may include numeric (i.e., digits) and non-numeric characters. In some embodiments, to determine a number of bits for a document, each non-numeric character in the document may be multiplied by a first multiplier (e.g., one), each digit in the document may be multiplied by a second multiplier (e.g., three), and the total number of bits in the document may be the sum of the values for characters and digits. Multipliers of one and three for characters and digits, respectively, are merely exemplary and any other suitable multipliers may be used to generate a total value for documents in an EMR. For example, each digit may be represented using a number of bits different from three, and each non-numeric character may be represented using a number of bits different from one. The multipliers for non-numeric characters and digits represented in a document may be the same or different and the techniques described herein are not limited by the particular multipliers that are selected.

In some embodiments, a medical record of a patient may include non-textual information, such as images (e.g., images generated using magnetic resonance imaging, computed tomography, ultrasound, etc.), flow sheets (i.e., a graphical representation of a changing factor, such as patient's vital signs, weight, treatments, etc.) or other types of non-textual information. A numerical value describing non-textual information may be expressed as bits using any suitable technique. In some implementations, textual information used to describe the non-textual information may be analyzed to determine a numerical value for the non-textual information. For example, a number of bits determined for characters in doctor's notes describing an image may be calculated to determine a complexity value to associate with the image. Though, any other suitable technique may be substituted as the techniques described herein are not limited in this respect.

In some embodiments, all information (optionally excluding metadata, as described above) in a medical record of a patient may be analyzed to determine a complexity of the patient. Such information may be referred to as lifetime information. Alternatively, information recorded in a medical record over a period of time may be analyzed. For example, information collected in an EMR over the last 24 hours may be analyzed. Though, it should be appreciated that the techniques described herein are not limited in this respect, and any part of information in a medical record of a patient, collected over any suitable period of time, may be analyzed to determine a complexity of the patient. For example, in some embodiments, an evaluation of a complexity of a patient using one or more techniques described herein may be performed continuously or periodically to provide a real-time determination of patient complexity. In embodiments where a 24-hour analysis of documents in an EMR is performed, the 24-hour period for analyzing documents may be a sliding window that is based on a time when the complexity determination is initiated.

Regardless of a specific technique or time period used to determine a complexity of a patient in accordance with the techniques described herein, the complexity may be used to determine a risk of an adverse event to the patient. For example, a higher complexity determined based on information in a patient's medical record may indicate a higher risk of an adverse event for the patient. As discussed above, a complexity value of a patient determined in accordance with some embodiments may be compared to a threshold value and if it is determined that the complexity value exceeds the threshold value, an indication that the complexity value exceeds the threshold may be output (e.g., on a user interface). An exemplary threshold for indicating a high risk of an adverse event based on an analysis of a patient's lifetime information in an EMR is 40,000 bits, although it should be appreciated, that any suitable threshold value may be selected and the techniques described herein are not limited by the selection of a particular threshold value.

In some embodiments, a numerical value calculated for a patient using the CR may be compared to more than one threshold value. In this way, the numerical value may be identified as belonging to a certain range of values, with each range corresponding to a certain level of risk of an adverse event. Though, it should be appreciated that the techniques described herein are not limited to a particular manner of analyzing the risk of an adverse event occurring to a patient determined using the CR.

In some embodiments, a risk of an adverse event determined using the CR may be used to determine an appropriate approach in treating the patient's condition in an effort to mitigate the risk of the adverse event from occurring to the patient. The determined approach may include, but is not limited to, allocation of resources of the hospital depending on the risk of an adverse event. For example, if a complexity of a patient exceeds a threshold value, the patient may be identified as a patient having a high risk of an adverse event. In such a case, appropriate medical practitioners, services, and any other resources may be allocated to address a condition of that patient. For example, rather than allowing the patient to be examined and/or treated by a less experienced doctor, a more experienced doctor may be assigned to the patient. Further, patients having a high risk of an adverse event may be examined more frequently than patients with a lower risk or no risk of an adverse event. It should be appreciated that any suitable measures may be taken with respect to a patient identified as having a risk of an adverse event to prevent the adverse event or decrease its risk of occurrence.

The CR in accordance with some embodiments may be implemented in any suitable manner. For example, the CR may be implemented in one or more suitable computing devices as software comprising computer-readable instructions stored in a tangible storage medium. The computer-readable instructions may be executed by one or more processors to implement the described techniques for determining a complexity of a patient and, based on the complexity, determining whether the patient has a risk of an adverse event.

The computing device implementing the CR may be any type of a computing device which may comprise or otherwise be associated with any other information that may be used for the described techniques. For example, the CR may be implemented by a computing device that may access medical records of patients so that the CR may process information in a medical record for each patient. The medical records may be stored in any number of any suitable storage as electrical medical records, in any suitable manner. Information in medical records may be collected, stored and accessed using any suitable techniques currently known or developed in the future, and embodiments are not limited in this respect. Further, it should be appreciated that embodiments are not limited with respect to a particular way in which the CR may be implemented and a manner in which the CR may access medical records.

The CR may be incorporated into or be otherwise associated with integrated healthcare information technology systems, such as the Powerchart® EMR system provided by Cerner Corporation. Though, the CR may be incorporated into or be otherwise associated with any other suitable technologies, either currently known or developed in the future.

In some embodiments, information generated by the CR, such as a quantitative measure of a complexity of a patient, may be presented via a user interface. The user interface may display to a user a complexity value computed for a patient. Further, any other suitable information may be displayed, such as a risk of an adverse event determined based on the complexity value, a risk of MAE, or any other suitable information, such as statistics associated with the computed values, using a suitable visual representation. In some embodiments, information on a complexity of a patient provided by the CR may be presented in a location that allows associating the information with the patient. For example, for a hospitalized patient that may be in a hospital bed, the information may be presented in the vicinity of the hospital bed. It should be appreciated, however, that information generated by the CR may be presented to a user in any suitable manner.

In some embodiments, the CR may operate in real time. For example, the CR may periodically compute a complexity value for a patient at certain time intervals (e.g., every 24 hours). The CR may also compute the complexity value in response to a triggering event, such as user input, addition of new information to a medical record of the patient, transfer of the patient to a new location in a hospital, or any other suitable triggering event. Further, the CR may be configured to utilize the entire medical record to compute a complexity value for a patient or any portion of the record acquired during a certain period of time. A CR may operate in any suitable manner including, but not limited to, receiving information used for computational analysis and any other parameters input from a user.

In some embodiments, complexity values determined in accordance with the techniques described herein may be calculated for a plurality of patients and the patients may be ranked based, at least in part, on their corresponding complexity values. For example, healthcare providers often make rounds, during which the healthcare providers visit patients admitted to the hospital. In some embodiments, information in the EMR of patients to be visited during rounds may be analyzed in accordance with the techniques described herein, and an indication of the complexity of the patients may be used to inform the treatment of patients during rounds. For example, patients determined to be at a higher risk of having an adverse event may be attended to more closely and/or more frequently than patients determined to be at a lower risk of having an adverse event. In this way, a complexity value for a patient may be used as a metric to prioritize treatment of patients in a group of patients. In some embodiments, a group of patients may be ranked based, at least in part, on their corresponding complexity value, and the ranking of patients may be output to a user. For example, the ranking of the patients may be output in one or more reports and/or on a user interface presented on a computer.

The above-described examples of using a value determined from a patient's medical record to assess the risk of an adverse event for a patient or group of patients are merely exemplary applications of using such a value, and other applications are also contemplated. For example, in some embodiments, a value for a medical record determined in accordance with the techniques described herein may be used to facilitate workload balancing for healthcare staff at a hospital or medical practice. For example, staffing of nurses in different wards at a hospital is often determined by the number of patients in each ward. However, in some instances, the number of patients in a ward may not adequately reflect the amount and/or type of care that patients in that ward are likely to require. By determining a complexity value for patients in different wards or departments of a hospital and using these complexity values for workload balancing, healthcare providers may be more efficiently staffed in the hospital to ensure that patients are being provided the best care possible. In implementations that use complexity values of patients to facilitate workload balancing, the CR may be integrated with one or more scheduling modules of a practice management system used by a hospital to allocate hospital resources including healthcare staff (e.g., nurses, physicians) to different areas of a hospital. In such an integrated system, the CR may interact with the scheduling module(s) to automatically perform workload balancing based, at least in part, on an analysis of complexity values for patients at the hospital. For example, the CR may inform the scheduling module to notify a nursing station in one ward at the hospital to report to a nursing station at another ward at the hospital in response to determining that more help is needed at the other ward.

Workload balancing may also extend to care after a patient has been discharged from a medical facility. Discharged patients are often instructed to follow up with a particular medical provider after leaving the medical facility, but the assignment of the particular medical provider is not typically based on a quantitative analysis of a medical record for the patient. In some embodiments, patients determined to be more complex based on one or more of the techniques described herein, may be assigned for follow up to more senior healthcare providers, whereas less complex patients may be assigned to more junior healthcare providers.

Another exemplary application for the use of complexity values determined for patients of a healthcare practice in accordance with the techniques described herein relates to supplementing documentation for healthcare payers such as insurance companies or government programs such as Medicare. A metric that is commonly used to determine an amount that a payer will pay to a hospital is the Case Mix Index (CMI). CMI is a measure of the relative cost or resources needed to treat the mix of patients at a hospital during a calendar year, with hospitals that treat sicker patients and thus requiring more resources to treat these patients having a higher CMI than other hospitals. CMI for a hospital is based on diagnostic codes assigned to patients at the hospital and this metric is used to adjust the average cost per patient (or day) for a given hospital relative to the adjusted average cost for other hospitals by dividing the average cost per patient (or day) by the hospital's calculated CMI. However, for some hospitals that expend a considerable amount of resources per patient, the CMI metric may exhibit a ceiling effect, which prevents such hospitals from being properly compensated for their services.

In some embodiments, complexity values for patients determined in accordance with the techniques described herein may be used, at least in part, to supplement the information provided by CMI in an effort to justify to a payer the costs of treating patients at a particular hospital, thereby potentially increasing the hospital's revenue. Accordingly, in some embodiments, a report submitted to a payer of healthcare services may include complexity value information for one or more patients at the medical practice during a particular time period for which the report is generated. The complexity values included in the report may demonstrate to the payer that the patients being treated at the hospital are considerably more complex than the average patient and thus require additional resources used to treat them. As such, the hospital may be able to better justify the expense of the resources to the payer than if the complexity values for patients were not included in the report.

Tables 1 and 2 illustrate by way of example two patients with low acuity and two patients with high acuity having different complexities. The CR allows for identifying patients that have a low acuity but are complex and therefore may be at risk of an adverse event. Moreover, complexity of acute patients may also be used in determining whether some of such patients are at a higher risk of adverse events than others.

Table 1 illustrates by way of example information on Patients A and B who may be characterized as of a low acuity. Patient A has coughing and laboring breathing and Patient B has a worsening anemia, and patients A and B have different non-life-threatening concurrent diagnoses. Because both patients A and B have low acuity, without the CR, each of the patients may be determined to have a low risk of an adverse event. However, as shown in Table 1, Patient B's complexity, as measured by the CR, is 4,152,486 bits, which, in some embodiments, may be taken as being about twenty-eight times above a hospital average. Table 1 shows that Patient B has complex concurrent diagnoses, including complex seizure disorder, Down syndrome, gastrointestinal disease, recurrent urinary tract infections, recurrent pneumonias, and question of cortical blindness. Thus, this patient's medical record comprises multiple documents that may be used to determine the high complexity of the patient. An adverse event that happened to Patient B was a major adverse event (“MAE”)—an unexpected cardiac arrest leading to death.

The CR may have been able to identify such a complex patient as having a high risk of adverse event and may thus have been used to alert medial processionals that Patient B was at high risk. Patient B may have been placed on a monitor, and it is likely that the cardiac arrest would have been detected immediately and Patient B could have been resuscitated successfully instead of dying. Thus, the CR provides a highly advantageous technique that may facilitate identification of complex patients and prevent adverse events, including MAEs.

Table 1 illustrates by way of example that the complexity of the medical record of Patient B was 4,152,486. The complexity may be determined as a sum of complexities of different documents in the medical record that each had different complexities. Thus, a flowsheet has a complexity of 1,526,206 bits, medical doctor (MD)'s notes have a complexity of 1,933,867 bits, nursing notes have a complexity of 133,558 bits, other notes—3585 bits, lab/radiology documents—271 bits, MAR—496,959 bits and orders—58,043 bits. It should be appreciated that the complexities of the documents illustrated in Table 1 are shown by way of example only and that the complexities of the documents may be represented as other suitable number of bits or using other suitable quantitative measures of complexity.

Table 2 illustrates by way of example information on Patients C and D having high acuity and different complexities. Both Patients C and D may be characterized as having a high acuity and thus at high risk for adverse events. Patient C may be identified as being more acute than Patient D, based on a type of Patient C's condition—an open skull fracture with traumatic brain injury. Patient D was hospitalized for an elective procedure. However, Patient D's complexity of 1,378,176, as measured by the CR, may be determined to be about ten times a hospital average. Patient D suffered an MAE—death within 24 hours of discharge from the hospital. If the CR had been in use, medical personnel would have been alerted that Patient D was at even greater risk and this patient might have stayed at the hospital longer following surgery before being discharged to home.

TABLE 1
Comparison between two low acuity patients with different complexities
Comparison between two low acuity patients with different complexities:
In patients with low acuity, complexity may be used to identify those at greater risk for adverse events.

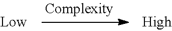

Low Acuity

| Patient A | | Patient B | |
|---|---|---|---|
| Principal Admission Diagnosis: | | Principal Admission Diagnosis: | |
| Coughing and Labored Breathing | | Worsening Anemia | |
| Concurrent Diagnoses: | | Concurrent Diagnoses: | |
| Seasonal Allergies | | Complex Seizure Disorder | |
| Frequent Upper Respiratory Infections | | Down Syndrome | |
| | | Gastrointestinal Disease | |
| | | Recurrent Urinary Tract Infections | |
| | | Recurrent pneumonias | |
| | | Question of cortical blindness | |
| Adverse Event: | | Adverse Event: | |
| None | | Unexpected Cardiac Arrest leading to death | |
| Complexity (bits) | | Complexity (bits) | |
| Flowsheet | 1,691 | Flowsheet | 1,526,206 |
| Includes vital signs, support, and some lab | | | |
| values | | | |
| MD Notes | 1,987 | MD Notes | 1,933,867 |
| Includes admission, discharge, and progress | | | |
| notes from physicians | | | |
| Nursing Notes | 741 | Nursing Notes | 133,558 |
| Includes admission, discharge, and progress | | | |
| notes from nurses | | | |
| Other Notes | 354 | Other Notes | 3585 |
| Includes notes from the emergency | | | |
| department and surgeries | | | |
| Lab/Radiology | 102 | Lab/Radiology | 271 |
| Includes hematology and chemistry values; | | | |
| documents from radiology | | | |
| MAR | 897 | MAR | 496,959 |
| Medication administration record, includes | | | |
| all dosing information | | | |
| Orders | 158 | Orders | 58,043 |
| Includes all items ordered by the physician | | | |
| through the pharmacy | | | |
| Total | 5,930 | Total | 4,152,486 |

TABLE 2
Comparison between two high acuity patients with different complexities.
Comparison between two high acuity patients with different complexities:
In patients with high acuity, complexity adds another dimension for identifying those at even greater risk for adverse events.

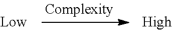

High Acuity

| Patient C | | Patient D | |
|---|---|---|---|
| Principal Admission Diagnosis: | | Principal Admission Diagnosis: | |
| Open skull fracture with traumatic brain injury | | Elective procedure | |
| Struck by automobile while walking | | | |
| Concurrent Diagnoses: | | Concurrent Diagnoses: | |
| None Specified | | Rare Genetic Disease | Hearing and Sight |
| | | (Kabuki Syndrome) | Impairment |
| | | Obstructive Sleep | Developmental |
| | | Apnea | Delay |
| | | Recurrent Ear | Seizure Disorder |
| | | Infections | |
| | | Feeding Tubes | Kidney dysfunction |
| | | Rickets | Chronic pneumonia |
| Adverse Event: | | Adverse Event: | |
| None | | Death 24-hours after discharge (Unknown | |
| | | Cause) | |
| Complexity (bits) | | Complexity (bits) | |
| Flowsheet | 79,429 | Flowsheet | 518,468 |
| Includes vital signs, support, and some lab | | | |
| values | | | |
| MD Notes | 9,640 | MD Notes | 642,444 |
| Includes admission, discharge, and progress | | | |
| notes from physicians | | | |
| Nursing Notes | 6,756 | Nursing Notes | 65,090 |
| Includes admission, discharge, and progress | | | |
| notes from nurses | | | |
| Other Notes | 938 | Other Notes | 4,110 |
| Includes notes from the emergency | | | |
| department and surgeries | | | |
| Lab/Radiology | 225 | Lab/Radiology | 1,314 |
| Includes hematology and chemistry values; | | | |
| documents from radiology | | | |
| MAR | 6,413 | MAR | 135,704 |
| Medication administration record, includes | | | |
| all dosing information | | | |
| Orders | 3,930 | Orders | 11,046 |
| Includes all items ordered by the physician | | | |
| through the pharmacy | | | |
| Total | 107,330 | Total | 1,378,176 |

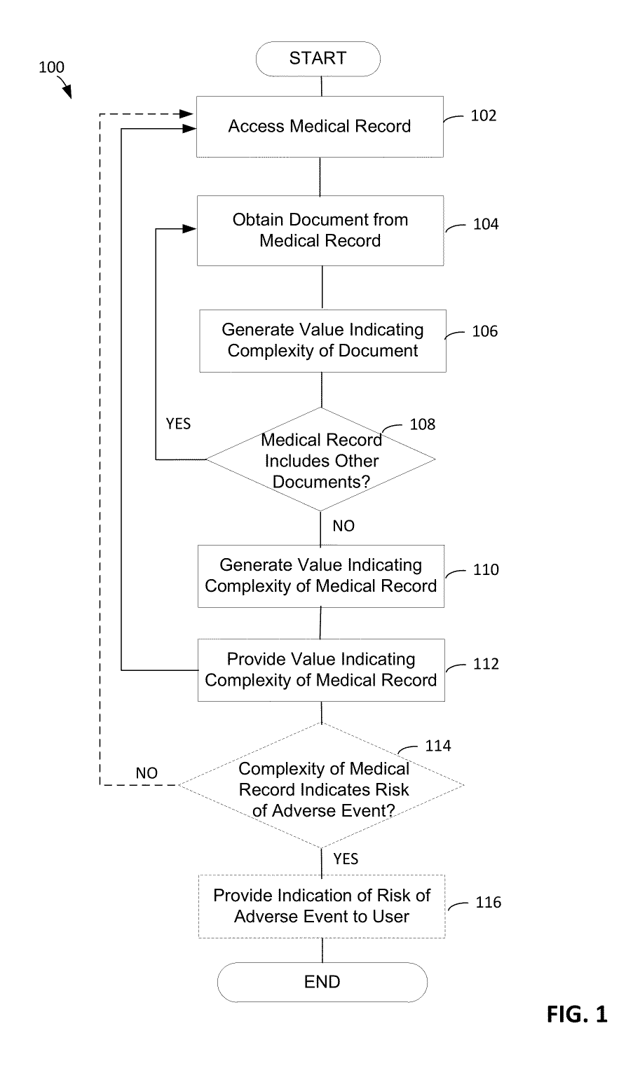

FIG. 1 illustrates a flowchart illustrating a process 100 for determining a numerical value indicative of a complexity of a patient, in accordance with the techniques described herein. As discussed above, the process 100 may be implemented as a computer-implemented technique referred to herein as the CR. Process 100 may be initiated at any suitable time. For example, process 100 may start in response to an activation of the CR on a computer system, which may be performed in any suitable manner. For example, user input, or any other trigger may be received instructing the CR to activate. In some embodiments, the CR may execute continuously on a computer system and a quantitative measure of a complexity of a medical record may be determined at certain time intervals or at any suitable time.

In act 102, an EMR of a patient may be accessed. The EMR may be formatted in any suitable manner and may be incorporated in any suitable hospital information technology system including, but not limited to, a commercially-available EMR system and a proprietary EMR system developed for a hospital. The medical record may be accessed in any suitable manner. For example, the CR may be configured to access a system comprising multiple electronic medical records to retrieve the patient's medical record and the system may be connected locally to a computer on which the CR is executing or the system may be connected remotely using one or more networks. In some embodiments, the CR may access a medical record generated and stored by an electronic medical record system.

After accessing an EMR, the process proceeds to act 104 where a document is accessed from the medical record. The document may be of any suitable type and format and may include clinical and any other information. For example, the document may be a doctor's note, nurse's note, lab report, radiology report, flowsheet comprising patient's vital signs or other information, image (e.g., an image generated using magnetic resonance imaging, computed tomography, ultrasound, etc.), or any other document.

After accessing the document from the medical record, the process proceeds to act 106, where the document is analyzed to determine a first value indicating a complexity of the document. As discussed above, in some embodiments, prior to generating a first value indicating a complexity of the document, the document may be processed in a suitable manner to remove metadata from the document. Alternatively, metadata may be identified in the document, but rather than being removed from the document, the identified metadata may merely be ignored during the determination of the first value.

The first value indicating the complexity of the document may be a numerical value and may be generated in any suitable way. For example, in some embodiments, the information in a document in the medical record may be represented as a suitable number of bits and the sum of the bits in the document may be used to generate a numeric value indicating a complexity of the document. In accordance with the techniques described herein, if the analyzed document comprises text, the characters in the text may each be represented as a number of bits. For example, each non-numeric character in the text may be represented as one bit and each digit in the text may be represented as three bits.

Other types of information in the medical record (e.g., images, flowcharts, etc.) may be represented in any manner that is suitable to describe the complexity of the information. Though, it should be appreciated that the information in the document may be represented in any other suitable manner to generate a numeric value indicating a complexity of the document. Furthermore, the numeric value may be any type of quantitative measure indicating a complexity of a document, as the techniques described herein are not limited in this respect.

After determining the first value for the accessed document, the process continues to act 108, where it is determined whether the medical record includes one or more other documents to be analyzed. For example, a medical record may include a plurality of documents, and at least one of these documents may be analyzed in accordance with the techniques described herein to determine a complexity of a patient. The plurality of documents in a medical record may include, but are not limited to, a medical provider note, an electronic medical administration record, a flowsheet, and patient care orders. If it is determined that the medical record includes another document to analyze, the process returns to act 104 to access the next document. The process continues to access additional documents and generate first values indicating the complexities of each document until it is determined in act 108 that there are no more documents to analyze. In this way, process 100 may generate first values indicating a complexity of a suitable number of documents in the medical record. The entire medical record or a portion of the medical record may thus be represented as a quantitative measure (e.g., a number of bits).

Regardless of a number and types of documents in the medical record, if it is determined in act 108 that the medical record does not include another document to be used in determining a complexity of the medical record, the process proceeds to act 110, where a second value reflecting the total complexity of all of the analyzed documents is determined. In some embodiments, the second value indicating the total complexity of the analyzed EMR documents may be determined by combining the first values indicating the complexity of each of the analyzed documents in the medical record. For example, first values indicating complexity of the documents may be added to provide the second value. In some embodiments, different documents in a medical record may be weighted differently, based on a type of information a document, a person who entered data into the document, and any other factors. For example, a medical doctor's note may be weighted differently than nurse's notes, while nurse's notes may be weighted differently than notes made by other medical personnel. Any suitable weighting of documents in an EMR may be used and the techniques described herein are not limited in this respect.

In some embodiments, the second value indicating the complexity of the patient may be associated with a confidence value, which provides an indication of the likelihood that the patient will have an adverse event. For example, in embodiments where the second value is compared to a threshold value to assess a risk that the patient is likely to have an adverse event, the confidence value may be determined based, at least in part, on how close to the threshold value the second value is. For second values that are close to the threshold value, the associated confidence value may be low, whereas for second values that are farther from the threshold value, the associated confidence value may be higher. In some embodiments, the confidence value may be determined based, at least in part, on one or more mathematical models for assessing risk based on an amount of bits in documents in a medical record. It should be appreciated that not all embodiments require the use of a confidence value and the techniques described herein are not limited in this respect.

In some embodiments that compare the second value to a threshold value, the threshold value may be dynamically set based, at least in part, on an analysis of the medical records of patients at a particular hospital. For example, although the threshold(s) for determining a risk of an adverse event may be set initially based on empirical data for patients at the hospital, the threshold(s) may be adjusted continuously or periodically based on additional information recorded in medical records for patients at the hospital, such that the thresholds are set adaptively rather than being fixed. Such an adaptive system may more accurately reflect the population of a particular hospital or medical practice by setting the thresholds according to the patients treated at the particular hospital or medical practice.

After determining the second value, the process proceeds to act 112, where the second value is provided to a user (e.g., a medical practitioner) in a suitable manner. For example, the second value may be presented on a user interface or otherwise provided to the user—e.g., provided in a report or other suitable document. In some embodiments, the second value may be provided to a user only in response to determining that the second value exceeds a threshold value. For example, the second value may be compared to a threshold value, and in response to determining that the second value exceeds the threshold value, an indication of the second value as exceeding the threshold value may be output to the user. The indication of the second value may be output to the user in any suitable way including, but not limited to audio, visual, or tactile output provided to the user via a user interface. Additionally, in some embodiments, the second value may be stored in a suitable manner in a suitable location. For example, in some embodiments, the second value may be stored in or may be associated with the corresponding patient's medical record.

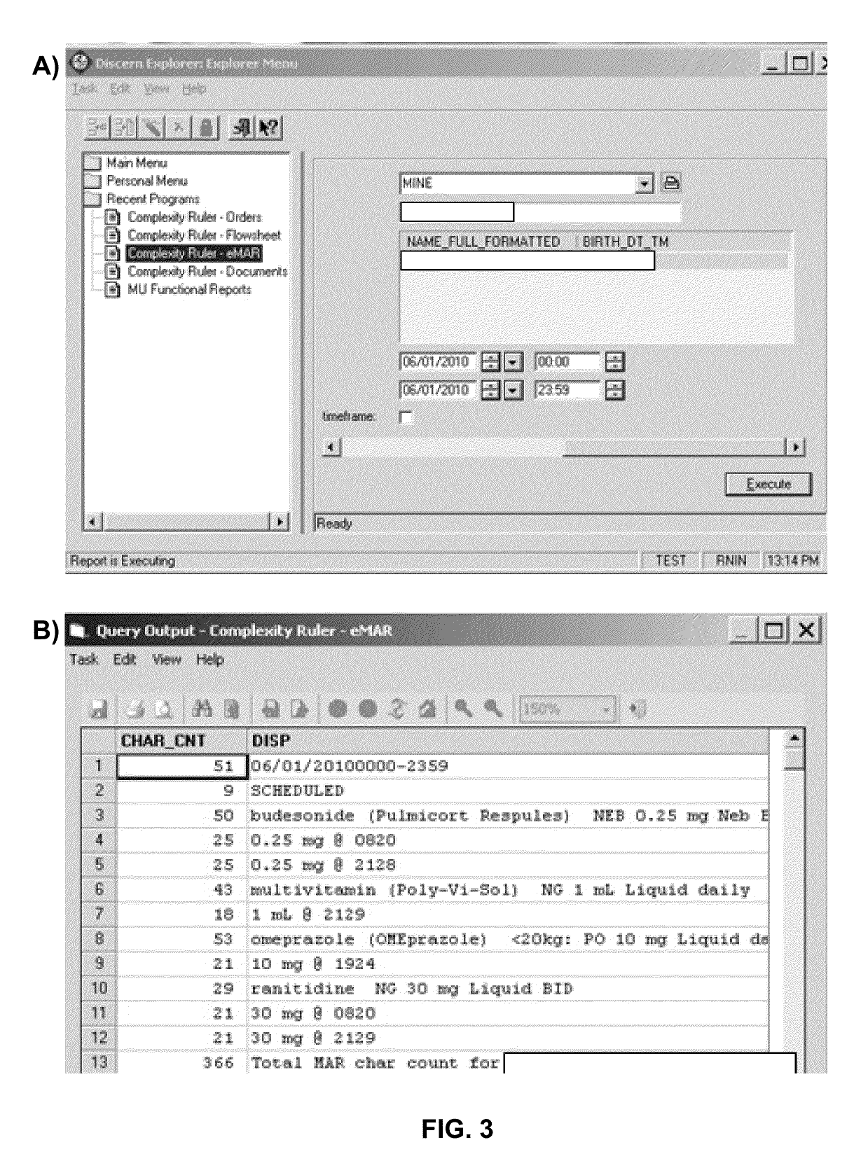

Exemplary portions of a user interface for use with the techniques described herein is illustrated in FIGS. 3A and 3B. FIG. 3A illustrates a portion of the user interface that a user may interact with to perform one or more actions including initiating a determination of the second value for a patient or patients at a hospital. For example, a user may interact with the user interface to select input information for the CR including, but not limited to, identification of one or more patients, a time period over which the second value(s) should be determined. The user may also interact with the user interface to select values for one or more other configuration variables (not shown) including, but not limited to, weighting factors, types of documents to include, and metadata to exclude from the determination of the second value. It should be appreciated that the user interface illustrated in FIG. 3A that is configured to receive user input is provided merely for explanatory purposes and any other suitable user interface may alternatively be used.

FIG. 3B illustrates another portion of an exemplary user interface configured to display output associated with analyzing an EMR in accordance with the techniques described herein. FIG. 3B shows analyzed textual information and corresponding character counts for the analyzed textual information from a document in a patient's EMR. Additionally, the user interface is configured to display a total character count for the analyzed document. It should be appreciated that the user interface illustrated in FIG. 3B that is configured to display output of the CR is provided merely for explanatory purposes and any other suitable user interface for displaying output generated in accordance with the techniques described herein may alternatively be used.

In some embodiments, the process may return from act 112 to act 102 to access another medical record. For example, as discussed above, in some embodiments, second values for each of a plurality of patients is determined and information regarding the complexity of the plurality of patients is output to a user. For example, the patients may be ranked based, at least in part, on their associated second value, and a ranking of the patients may be output to the user. The output relating to a complexity for a plurality of patients may also be used for purposes other than determining a risk of an adverse event and these purposes may include, but are not limited to, facilitating workload balancing, and providing documentation for one or more payers of medical services provided by a healthcare provider.

Additionally, the complexity of the same medical record may be recomputed after a certain period of time. As discussed above, in some embodiments, a complexity of a patient's medical record may be computed for the last 24 hours or any other recent period of time. The complexity may also be computed over a longer period of time. For example, a complexity over a lifetime of the patient, referred to as a “lifetime” complexity of the patient may be determined. The “lifetime” complexity may be determined based on an aggregation of documents in a medical record of the patient irrespective of when the documents were added to the medical record. Alternatively, the “lifetime” complexity of a patient may be determined based on one or more values representing a complexity over shorter period of times, a number of hospital visits, etc.

In some embodiments, a risk of an adverse event may be determined based, at least in part, on the determined complexity of the medical record. Accordingly, FIG. 1 shows schematically that process 100 may include acts 114 and 116. In act 114, it is determined whether the computed complexity of the medical record indicates a risk of an adverse event. Any suitable technique may be used to determine whether the complexity of the medical record indicates a risk of an adverse event. For example, the value of the complexity may be compared to one or more suitable thresholds. In some embodiments, the complexity of the medical record may be used to identify different levels of a risk of an adverse event. The level of the risk may increase as the value of the complexity increases. In embodiments in which different levels of risk are determined, an indication of the determined level of risk may be output to a user in any suitable way. For example, in one implementation, a level of risk may be associated with a different color indicator displayed on a user interface of a computer. Exemplary color indicators may be a green indicator for low-risk patients, a yellow indicator for moderate-risk patients, and a red indicator for high-risk patients. It should be appreciated that any other suitable indicators may alternatively be used and the techniques described herein are not limited in this respect.

Regardless of whether an analysis including different levels of risk is performed, more generally if it is determined that the complexity of the medical record indicates a risk of an adverse event, the process proceeds to act 116, where an indication of the risk of an adverse event may be provided in a suitable manner. For example, the indication may be presented on a user interface, provided to a user (e.g., a medical practitioner) in an audible manner, or otherwise communicated to the user. For example, a medical practitioner may be alerted that a certain patient is characterized by a high complexity and therefore needs certain attention to decrease a risk of an adverse event. In some embodiments, one or more recommendations regarding measures to decrease the determined risk of an adverse event may also be provided to the user in any suitable way. It should be appreciated that acts 114 and 116 are optional. If it is determined in act 114 that the determined complexity of the medical record does not indicate a risk of an adverse event, process 100 may end.

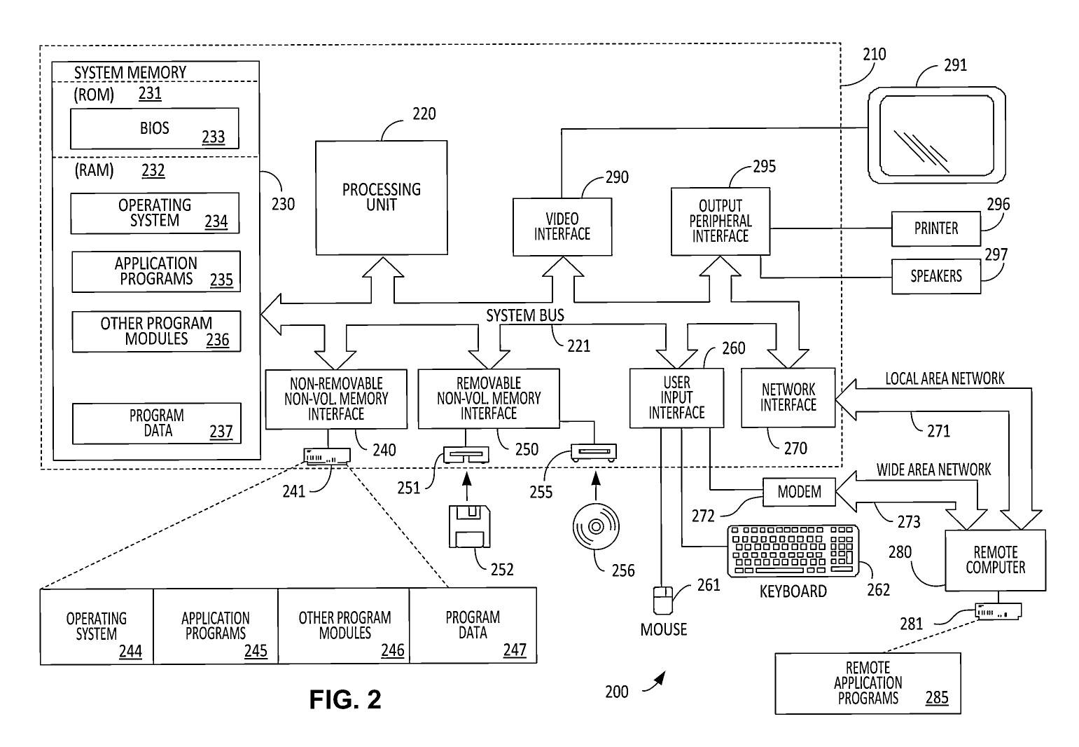

FIG. 2 illustrates an example of a suitable computing system environment 200 on which some embodiments may be implemented. It should be appreciated that the computing system environment 200 is only one example of a suitable computing environment and is not intended to suggest any limitation as to the scope of use or functionality of the embodiments. Neither should the computing environment 200 be interpreted as having any dependency or requirement relating to any one or combination of components illustrated in the exemplary operating environment 200.

Some embodiments are operational with numerous other general purpose or special purpose computing system environments or configurations. Examples of well-known computing systems, environments, and/or configurations that may be suitable for use with embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. Some embodiments may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing some embodiments includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

The following describes several working examples of the use of the techniques described herein. These examples are provided merely for explanatory purposes and do not limit the application of any of the techniques described herein in any respect.

### Example 1

### Correlation of Complexity Value with Physician Rating of Complexity

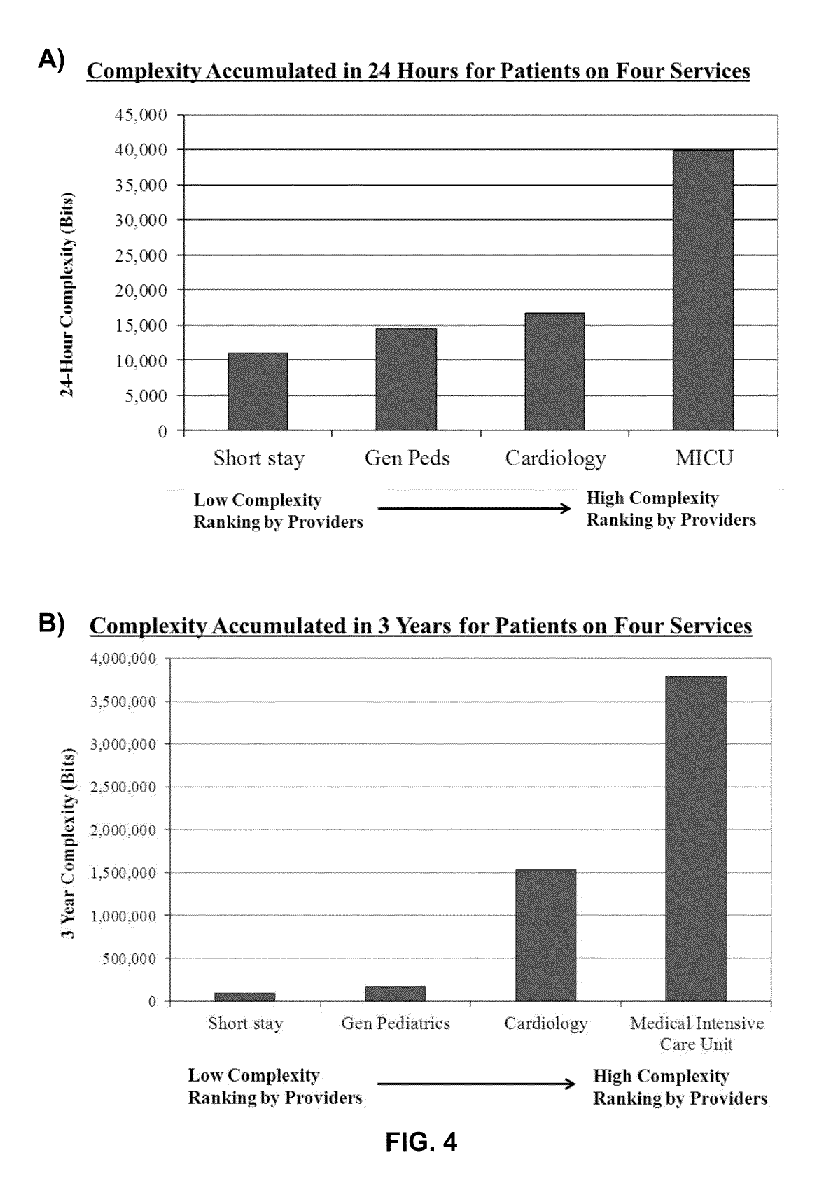

The average patient complexity on four different services (Short stay, General Pediatrics, Cardiology, and Medical Intensive Care Unit) with each service having five patients was determined using the techniques described herein. The determined values were compared with experienced physicians' ratings of the complexity of the patients on these services. As shown in FIGS. 4A and 4B, complexity as measured by the CR correlates with the complexity rankings of experienced clinicians.

### Example 2

### Comparison of Complexity Value with Risk Factor for Major Adverse Event

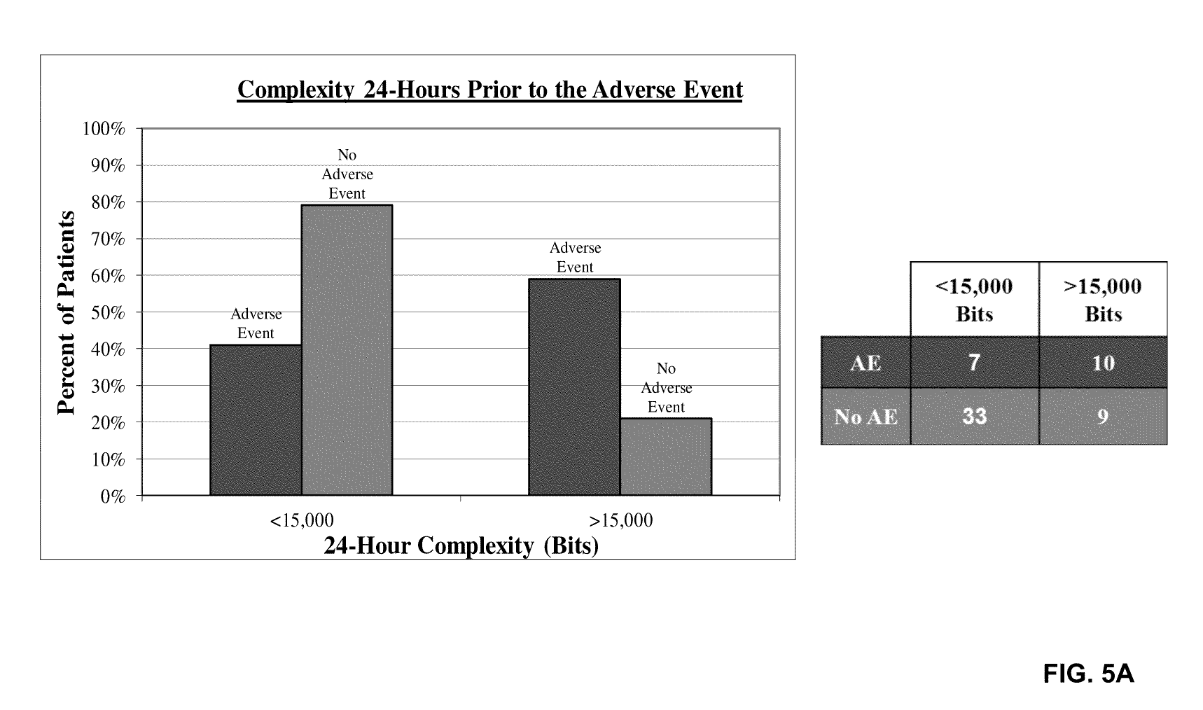

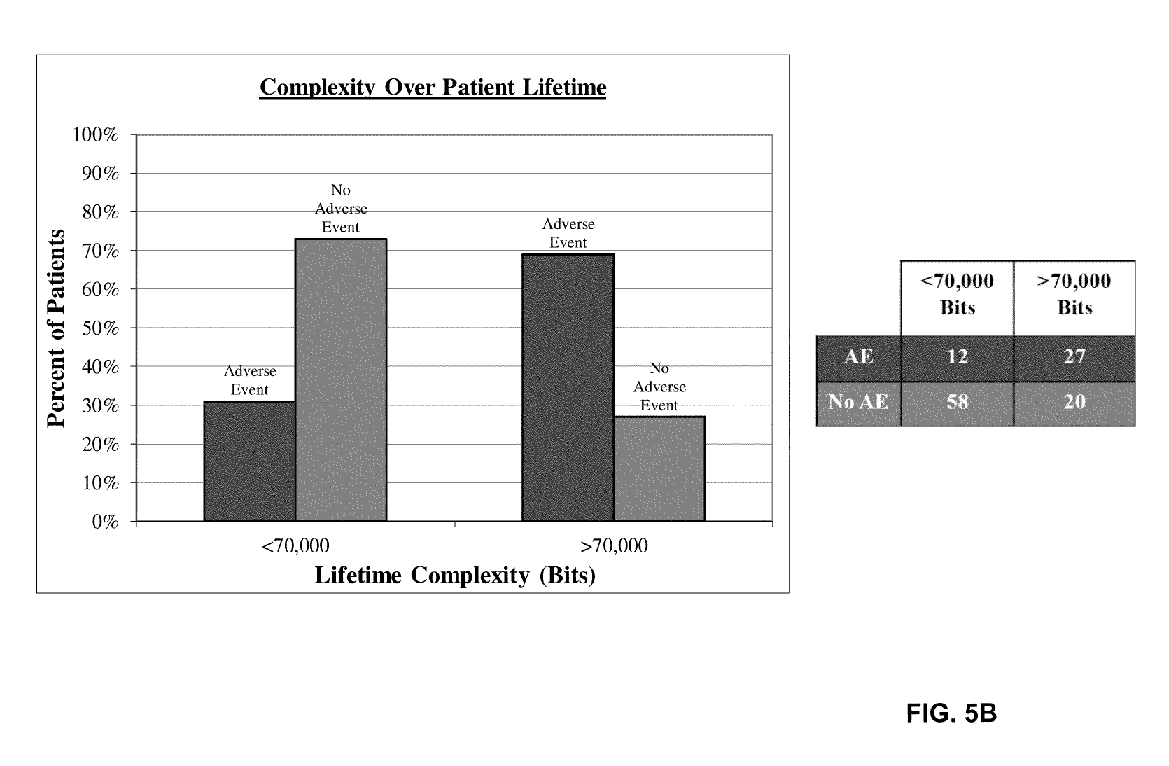

Patient complexity determined in accordance with the techniques described herein was computed for patients who had an externally-reportable major adverse event and randomly selected control patients who were admitted to Boston Children's Hospital during the same time period. Patient complexity was measured for each of these patients using two different time periods. FIG. 5A illustrates the results for patient complexity determined during a 24-hour time period immediately prior to the occurrence of the adverse event (MAE patients) or during a randomly selected 24-hour period (control patients). As shown in FIG. 5A, patients who had more than 15,000 bits in their chart during the 24-hour period had 5.24 times the odds of experiencing a major adverse event compared to control patients. FIG. 5B illustrates the results for patient lifetime complexity determined based on analysis of all information in the patients' medical chart over their lifetime. As shown in FIG. 5B, patients who had more than 70,000 bits in their chart over their lifetime had 6.53 times the odds of experiencing an adverse event. The thresholds of 15,000 bits and 70,000 bits were empirically derived to maximize the differences between groups.

### Example 3

### Comparison of Patient Complexity with Risk Factor for Unplanned Readmission to Hospital

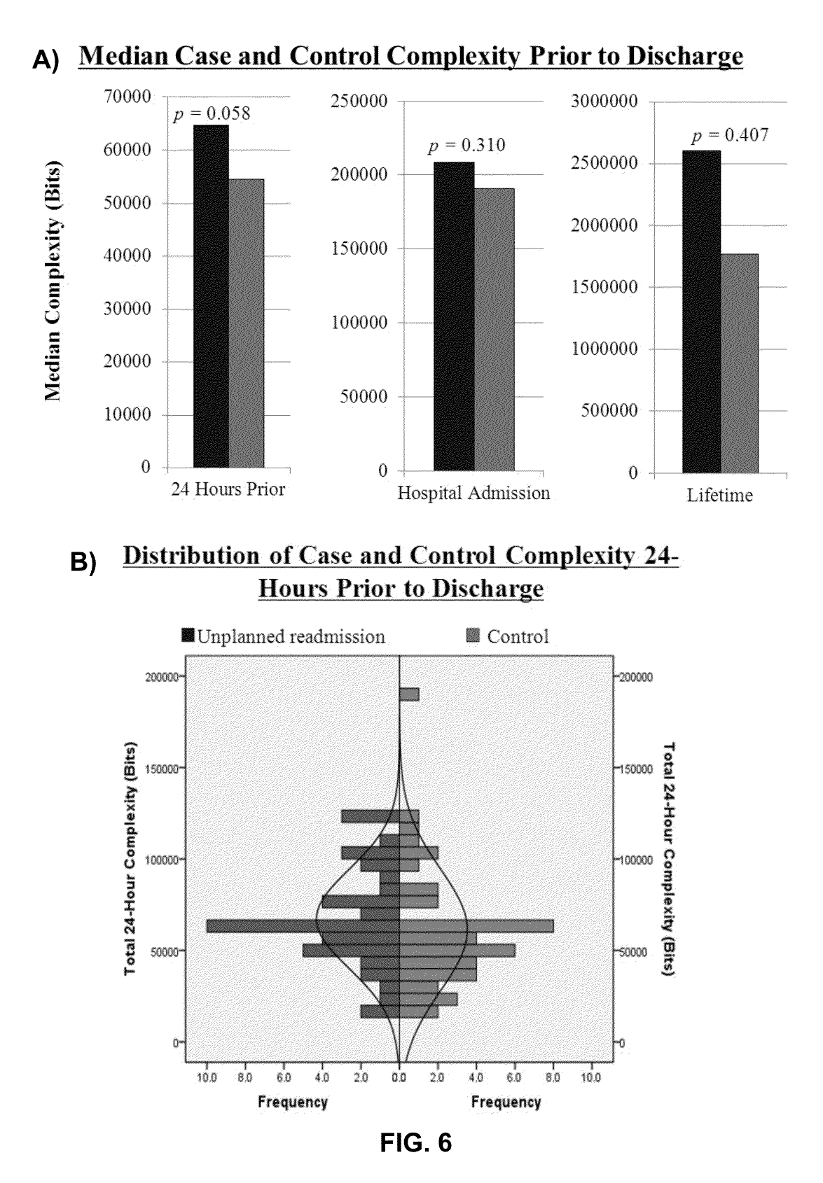

Patient complexity determined in accordance with the techniques described herein was computed for patients who were discharged from the Complex Care Service (CCS) of Boston Children's Hospital. Group 1 included patients who were non-electively readmitted within seven days from discharge and group 2 included patients discharged on the same day as group 1 patients, but who were not non-electively readmitted within seven days from discharge. Patient complexity was measured for each of these patients using three different time periods (24-hour prior to discharge, admission, and lifetime complexity). FIG. 6A illustrates the results for patient complexity determined during each of these time periods for the two groups of patients. As shown in FIG. 6A, group 1 patients had a median patient complexity that was higher than the median patient complexity for group 2 patients during each of the time periods for which the complexity value was measured. FIG. 6B illustrates the distribution of group 1 and group 2 complexity values during the 24-hour time period over which the complexity value was determined. These results support the notion that complexity is associated with a modest increased risk of unplanned readmission, but may not be, by itself, of high predictive value.

### Example 4

### Comparison of Patient Complexity with Risk Factor for Unplanned Transfer to an Intensive Care Unit (ICU)

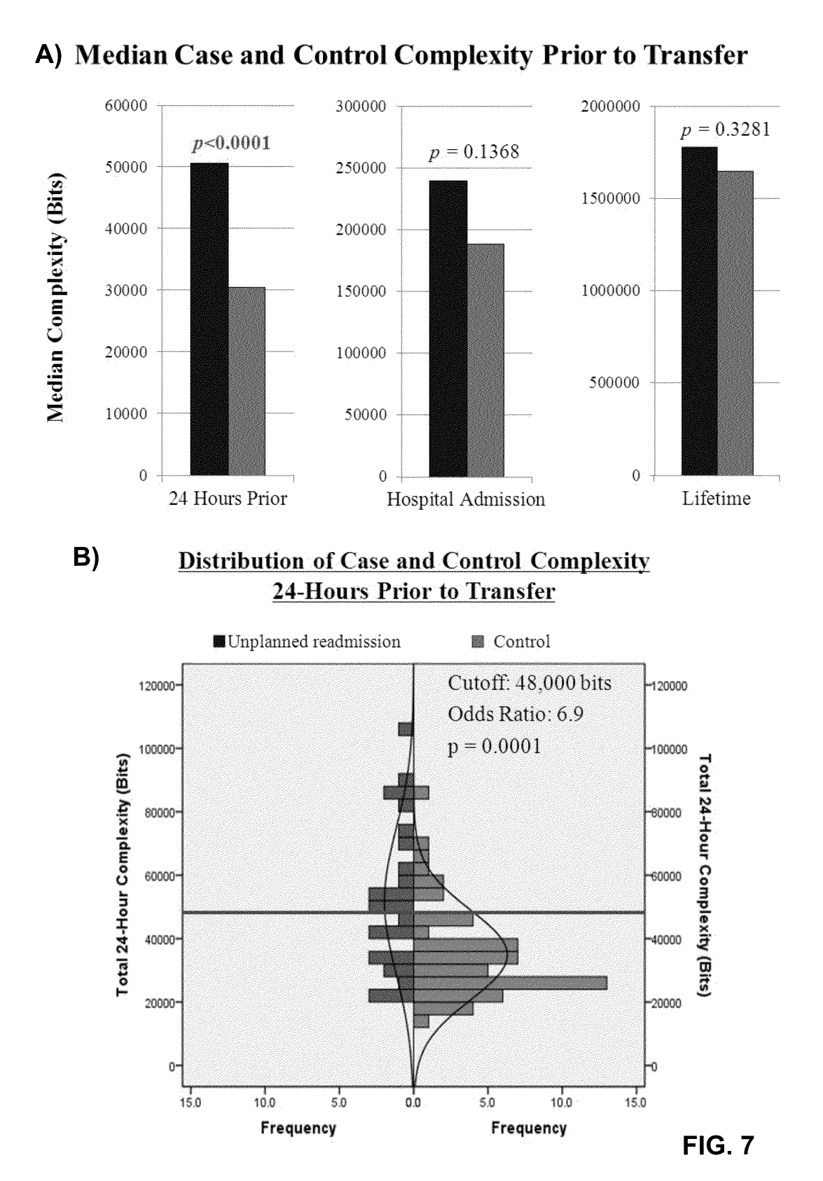

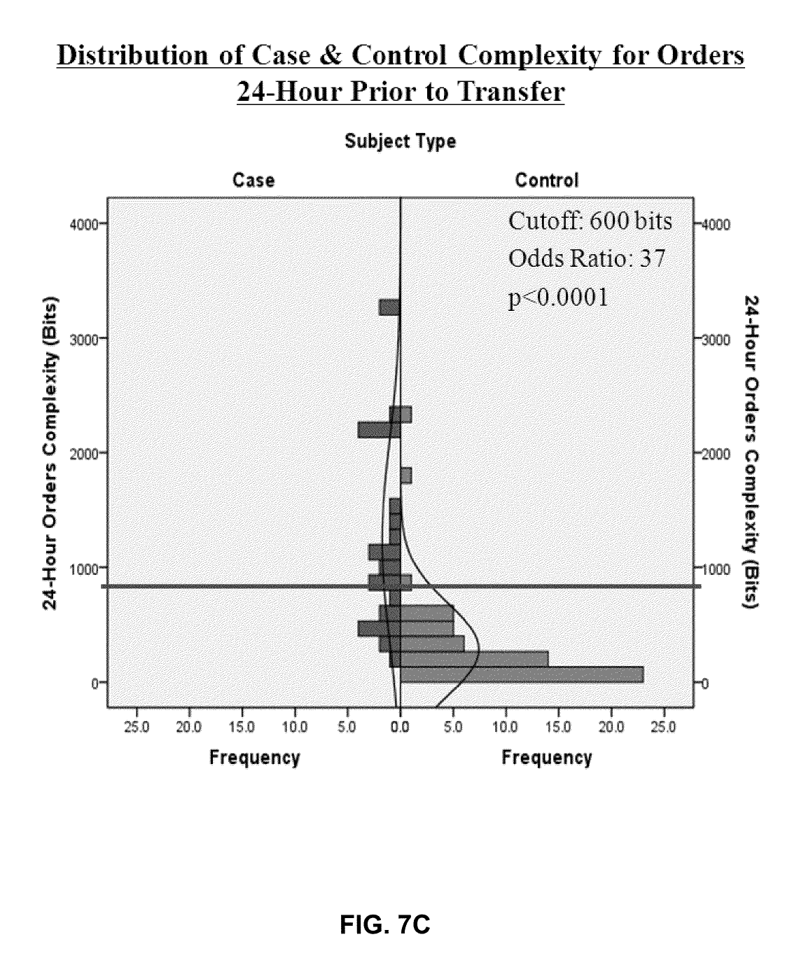

Patient complexity determined in accordance with the techniques described herein was computed for patients admitted to the Complex Care Service (CCS) of Boston Children's Hospital. Group 1 included patients who had an unplanned transfer to an ICU/ICP from CCS and group 2 included patients who did not have an unplanned transfer to an ICU/ICP from CCS and who were admitted to CCS on the same day as the patients in group 1. Patient complexity was measured for each of these patients using three different time periods (24-hour prior to transfer, admission, and lifetime complexity). FIG. 7A illustrates the results for patient complexity determined during each of these time periods for the two groups of patients. As shown in FIG. 7A, patients who had more than 48,000 bits in their medical record during the 24-hour period prior to transfer had 6.9 times the odds of having an unplanned transfer to the ICU. FIG. 7B illustrates the distribution of group 1 and group 2 patient complexity values during the 24-hour time period over which the complexity value was determined FIG. 7C illustrates the distribution of group 1 and group 2 patient complexity values during the 24-hour time period when only orders documents in the patients' medical records were used to determine the complexity values. As shown in FIG. 7C, patients who had more than 600 bits in the orders section of their medical record had 37 times the odds of having an unplanned transfer to the ICU. The thresholds of 48,000 bits and 600 bits were empirically derived to maximize the differences between groups. As should be appreciated from this example, complexity values determined over a 24-hour time period is significantly associated with unplanned transfer to the ICU.

Having thus described several aspects of at least one embodiment, it is to be appreciated that various alterations, modifications, and improvements will readily occur to those skilled in the art.

In exemplary embodiments described above, a complexity of a patient may be determined using a quantitative approach involving generating a numerical value indicating an amount of information in a medical record of a patient. However, it should be appreciated that, additionally or alternatively, a complexity of the patient may be determined using any other suitable information, as embodiments of the invention are not limited in this respect.

Furthermore, the CR may be implemented in any suitable manner and may be associated in any suitable way with any system for processing medical records of patients. Information on the patient's complexity and risk of adverse events generated using the CR may be provided to a user (e.g., a medical practitioner) in any suitable manner. For example, the information may be provided in a report, displayed on a user interface of a suitable device (which may be a portable device), or provided to the user in any other suitable manner that allows the user to appreciate that the patient has a risk of an adverse event. Moreover, information provided by the CR may be provided in association with any suitable information comprising recommendations or instructions regarding measures to be taken with respect to the patient having a risk of an adverse event, so that the risk may be reduced and the adverse event may be prevented.

Such alterations, modifications, and improvements are intended to be part of this disclosure, and are intended to be within the spirit and scope of the embodiments. Accordingly, the foregoing description and drawings are by way of example only.

The above-described embodiments may be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, embodiments may be instantiated as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the embodiments may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments may be provided as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of analyzing an electronic medical record (EMR), wherein the EMR includes at least one document, the method comprising:
assigning to each document of the at least one document, a first value, wherein the assigning is based, at least in part, on a number of characters and/or a number of digits included in each document of the at least one document;
determining, with at least one processor, a second value, wherein the second value is determined based, at least in part, on the first value assigned to each document of the at least one document;
determining whether the second value is above a threshold value; and
outputting an indication that the second value is above the threshold value in response to determining that the second value is above the threshold value.

2. The method of claim 1, wherein the assigning a first value to each document comprises:
multiplying the number of characters in the document by a first multiplier to produce a character value;
multiplying the number of digits in the document by a second multiplier to produce a digit value; and
adding the character value and the digit value to produce the first value for the document.

3. The method of claim 2, wherein the first multiplier and the second multiplier are different.

4. The method of claim 1, further comprising:
identifying metadata information in a first document of the at least one document, wherein the assigning a first value to the first document comprises excluding characters and/or digits in the identified metadata information.

5. The method of claim 1, wherein a first document of the at least one document includes non-textual information, and wherein the assigning a first value to the first document comprises processing text describing the non-textual information in the first document.

6. The method of claim 5, wherein the non-textual information comprises an image and wherein the text comprises text-based notes describing the image.

7. The method of claim 1, further comprising:
determining a set of documents added to the EMR during a particular time period, wherein the at least one document to which a first value is assigned is included in the set of documents.

8. The method of claim 7, wherein the set of documents added to the EMR during a particular time period includes all documents in the EMR.

9. The method of claim 1, wherein the at least one document comprises at least two documents, and wherein determining a second value comprises combining the first values determined for the at least two documents.

10. The method of claim 1, further comprising:
determining the second value for each of at least two EMRs;
ranking the EMRs based, at least in part, on the second values; and
outputting on a user interface, an indication of the ranking of the EMRs.

11. The method of claim 10, further comprising:
assigning at least one healthcare resource based, at least in part, on the ranking of the EMRs.

12. The method of claim 11, wherein the at least one healthcare resource comprises healthcare personnel.

13. The method of claim 1, further comprising:
storing in the EMR, the indication of the second value and/or the first value determined for the at least one document.

14. The method of claim 1, further comprising:
generating a report for submission to at least one payer, wherein the report includes the second value.

15. The method of claim 1, further comprising:
associating a confidence value with the second value, wherein the confidence value indicates a likelihood that a patient associated with the EMR is at risk of having an adverse event; and
outputting an indication of the confidence value.

16. The method of claim 1, further comprising:
adjusting the threshold value based, at least in part, on the second value.

17. A computer-readable storage medium for use with a computer configured to store an electronic medical record (EMR), wherein the EMR includes at least one document, wherein the computer-readable storage medium is encoded with a plurality of instructions that, when executed by the computer, performs a method, comprising:
assigning to each document of the at least one document, a first value, wherein the assigning is based, at least in part, on a number of characters and/or a number of digits included in each document of the at least one document;
determining a second value, wherein the second value is determined based, at least in part, on the first values assigned to each document of the at least one document;
determining whether the second value is above a threshold value; and
outputting an indication that the second value is above the threshold value in response to determining that the second value is above the threshold value.

18. The computer-readable storage medium of claim 17, wherein the assigning a first value to each document comprises:
multiplying the number of characters in the document by a first multiplier to produce a character value;
multiplying the number of digits in the document by a second multiplier to produce a digit value; and
adding the character value and the digit value to produce the first value for the document.

19. The computer-readable storage medium of claim 17, wherein the method further comprises:
identifying metadata information in a first document of the at least one document, wherein the assigning a first value to the first document comprises excluding characters and/or digits in the identified metadata information.

20. The computer-readable storage medium of claim 17, wherein a first document of the at least one document includes non-textual information, and wherein the assigning a first value to the first document comprises processing text describing the non-textual information in the first document.

21. The computer-readable storage medium of claim 17, wherein the method further comprises:
storing in the EMR, the indication of the second value and/or at least one of the first values determined for the at least one document.

22. A computer system, comprising:
at least one storage device configured to store an electronic medical record (EMR), wherein the EMR includes at least one document;
a user interface configured to display information to a user; and
at least one processor programmed to:
assign to each document of the at least one document, a first value, wherein the assigning is based, at least in part, on a number of characters and/or a number of digits included in each document of the at least one document;
determine a second value, wherein the second value is determined based, at least in part, on the first values assigned to each document of the at least one document;
determine whether the second value is above a threshold value; and
output via the user interface, an indication that the second value is above the threshold value in response to determining that the second value is above the threshold value.
